(19) United States
(12) Patent Application Publication
(10) Pub. No.: US 2008/0136914 A1
(43) Pub. Date: Jun. 12, 2008

(54) Mobile monitoring and surveillance system for monitoring activities at a remote protected area

(76) Inventors: Craig Carlson, Vernal, UT (US); David E. Gurr, Vernal, UT (US)

Correspondence Address: iPA, 400 GARDEN CITY PLAZA STE 101, GARDEN CITY, NY, 11530, US

(21) Appl. No.: 11/634,912

(22) Filed: Dec. 7, 2006

(51) Int. Cl. H04N 7/00

(52) U.S. Cl. 348/155; 348/E07.091

(57) ABSTRACT

A mobile, integrated, self-contained surveillance system providing motion detection, audio and video capture, and audible alarm capabilities and capable of operation from solar power alone. The system implemented on a trailer configured to be towed by a motor vehicle. The system may be towed to a site or area to be monitored and protected. The system is capable of reporting and transmitting video and images wireless to one or more recipients.

### FIELD OF THE DISCLOSURE

The disclosures made herein relate generally to surveillance systems for protecting property and, more particularly, to mobile integrated self-contained surveillance systems providing motion detection, audio and video capture, wireless transmission of surveillance images and audio to a recipient, and are capable of operation without external electric power.

### BACKGROUND

In the prior art is it known to monitor residences, retail shops and business offices using commercially available sensors such as motion sensors, video cameras, video recording equipment, and alarm systems. In such systems undesirable events such as forced entry, robberies, vandalism and other illegal acts are detected, in some cases recorded and in some cases automatically reported to remote alarm monitoring centers or to local authorities.

A limitation of such prior art security systems is that they are generally installed in and fixed to one location, store, residence or building and can not be readily moved at will from site to site as desired.

At certain sites, such as construction sites for one example, the site is normally not manned 24 hours. The site may have equipment and materials on site which may need to be protected. In the prior art it is known to employ a security guard or security agency to patrol the site and watch for unwanted activity.

A limitation of the use of security services such as security guards is hourly expense to employ such security guards.

Therefore, a monitoring and surveillance system that is transportable to a remote site, a monitoring and surveillance system that provides unattended video and motion detection surveillance, video capture, and reporting, a monitoring and surveillance system that can eliminate the need to employ a security guard service, a monitoring and surveillance system that is self contained and powered directly from sunlight, a monitoring and surveillance system that can report alarms and provide surveillance video and images to one or more recipients, including law enforcement, a monitoring and surveillance system that eliminates hardware installation and wiring requirements, such a mobile monitoring and surveillance system would be useful and novel.

### SUMMARY OF THE DISCLOSURE

Accordingly, embodiments of the inventive disclosures made herein comprise various embodiments of a mobile monitoring and surveillance system for monitoring activities at a remote protected area.

In a first embodiment, the mobile monitoring and surveillance system for monitoring activities at a remote protected area, the system includes a wheeled trailer having a frame and a weather tight enclosure secured to the trailer frame. On the roof of the trailer are one or more panels having an array of solar voltaic cells for converting sunlight into electricity to power the surveillance system. The surveillance system includes an energy storage means comprising at least one rechargeable battery, such as a storage battery for one example. The energy storage means is charged by the solar voltaic cells. The energy storage means provide power during periods of low or insufficient lighting, such as evening for example, when the solar cell arrays will not generate sufficient power to operate the surveillance system. The mobile monitoring and surveillance system includes a conventional DC to AC power inverter for provinding conventional 120 VAC to electronic devices in the surveillance system from the energy storage means or batteries. The inverter is electrically connected to the energy storage means and solar voltaic cells. The surveillance system includes a computer system secured to the interior of the enclosure. The computer system having programmable logic control functionality for surveillance monitoring, motion detection and the automatic capture of images and video and transmission of captured images/video to one or more recipients. The computer system having a processor, read/write memory, a non-volatile storage means for storing an operating system, application software, recorded video and audio surveillance data and surveillance configuration information (for example a hard disk, or flash memory, or a combination of flash memory and read only memory (ROM). The computer further includes a keyboard, mouse, and at least one display monitor. The computer is fitted with interface cards to interface video cameras, motion sensors and other devices to the computer system. A plurality of motion sensors are secured to the exterior of the enclosure. The motion sensors are positioned to monitor the region around the mobile monitoring and surveillance system, a 360 degree coverage area. The motion sensors are electrically interfaced to the computer system. A plurality of video cameras are secured to the roof of the enclosure, the cameras positioned to provide 360 degree coverage of the area about the enclosure. Each camera is electronically interfaced to the computer system such that the computer system can activate, deactivate and record video or images from each camera. The cameras in certain embodiments have infrared night vision capabilities permitting the cameras to operate in low to no light. The mobile monitoring and surveillance system includes one or more digital video recorders having audio and video recording capabilities, the digital video recorders interfaced to the computer system, the video recorder for recording still images as well as motion images from the video cameras together with audio under the direction and control of the computer system. A siren is secured to the enclosure and electrically interfaced to the computer system for annunciating when an intrusion has been detected (the presence of motion picked up by the motion sensors). The mobile monitoring and surveillance system includes one or more heaters for warming electronic devices such as the digital video recorders in very cold weather conditions. A cellular phone device having a cellular modem is interfaced to the computer control system of the mobile security system. The cellular device provides Internet access capabilities to the computer system for the transmission of security video and still images to a recipient. A plurality of flood lights are secured to the roof of the enclosure and positioned to illuminate a 360 degree coverage area around the enclosure. Each flood light is electrically connected to the energy storage means and controlled by the computer system such that when motion is detected the computer may illuminate an area about the surveillance system in a direction where the motion was detected for better video image capture. At least one communications antenna is secured to the enclosure and electrically interfaced to the cellular phone device providing wireless communications capabilities.

The mobile monitoring and surveillance system for monitoring activities at a remote protected area performs its intended mission by watching for the presence of motion in the protected area about the surveillance system. The motion sensors each have adjustable range/sensitivity settings such that the motion sensors can be configured to ignore movement outside the protected area.

In at least one embodiment the motion sensors are commercially available passive infrared sensors (PIRs), which are electronic devices that detect the motion of infrared emitting source such, as advantageously herein, usually a human body. The term “passive” in this instance means the PIR does not emit any energy of any type but merely sits ‘passive’ accepting infrared energy through the ‘window’ in its housing. The heart of the PIR sensor is a solid state ‘chip’ often from a pyroelectric material, mounted on a printed circuit board which also contains the necessary electronics required to interpret the signals from this chip. An intruder entering the protected area is detected when the infrared energy emitted from his body is focused by a Fresnel lens (built into the PIR) or a mirror segment and overlaps a section on the chip which had previously been looking at some much cooler part of the protected area. That portion of the chip is now much warmer than when the intruder wasn't there. As the intruder moves, so does the hot spot on the surface of the chip. This moving hot spot causes the electronics connected to the chip to activate a contact output thereby activating the detection input provided to the surveillance system computer system. The surveillance system is not limited to the use of PIR motion detectors, the discussion herein presented is just one enabling embodiment of the inventive disclosures herein.

When motion is detected within the protected area (the range of the motion sensors) the siren and lights are triggered by the computer system and the computer system activates cameras to capture video images. In certain embodiments the cameras are CCD night/day infrared cameras and can function in low to no light conditions. Some CCD night/day infrared cameras offer black and white images in low light and color images during direct sunlight or when provided with external illumination (such as from the flood lights provided on the enclosure).

One example (for enablement) of such a night/day CCD camera device is offered by Advanced Security Products as model SSC-49MWC and features a Sony super HAD CCD camera lens surrounded by 28 IR light emitting diodes (LEDs) of the 850 nm wavelength carbonate composite variety, providing low power consumption IR illumination which is invisible to the human eye. This particular, exemplary CCD video camera is specified to have a visible range in darkness, relying entirely on low power IR LEDs, of 30 meters. The range, of course, is increased dramatically with the use of the flood lights on the surveillance system. The exemplary CCD video camera has color vision in visible light and black and white vision in low/no light/IR LED lighting, and is provided in a weatherproof housing. The disclosure is not limited to the use of this particular exemplary CCD camera device, the device particulars provided solely for enabling purposes. One advantage of these infrared LEDs is that the illumination they produce is invisible to the human eye and therefore not detected by an intruder.

The computer system records the images to the non-volatile storage means or to one of the digital video recorders in the surveillance system. Captured images may optionally transmit to a recipient via the cellular phone connection to the Internet.

In at least one embodiment, the mobile monitoring and surveillance system for monitoring activities at a remote protected area also includes a satellite transmitter/receiver connected to a satellite antenna secured to the outside of the enclosure, the satellite transmitter/receiver transmitting security images and video to a recipient via satellite.

In at least one embodiment, the mobile monitoring and surveillance system for monitoring activities at a remote protected area the system is capable of reporting intrusions directly to a law enforcement agency.

It is an objective of the inventive disclosure made herein to provide a mobile monitoring and surveillance system that is transportable to a remote site.

It is another objective of the inventive disclosure made herein to provide a mobile monitoring and surveillance system that provides unattended video and motion detection surveillance, video capture, and reporting.

It is another objective of the inventive disclosure made herein to provide a mobile monitoring and surveillance system that can eliminate the need to employ a manned security guard service.

It is another objective of the inventive disclosure made herein to provide a mobile monitoring and surveillance system that is self contained and powered directly from sunlight.

It is another objective of the inventive disclosure made herein to provide a mobile monitoring and surveillance system that can report alarms and provide surveillance video and images to one or more recipients, including law enforcement.

It is another objective of the inventive disclosure made herein to provide a mobile monitoring and surveillance system that eliminates on-site hardware installation and wiring requirements.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one embodiment of a mobile monitoring and surveillance system in accordance with the inventive disclosures herein.

FIG. 2 depicts a view of additional motion sensor locations depicted by ‘A’ of FIG. 1 in accordance with the inventive disclosures herein.

FIG. 3 is a flow diagram of a method of detecting, capturing images and reporting undesirable activity in accordance with the inventive disclosures herein.

FIG. 4 is a block diagram of one embodiment of a mobile monitoring and surveillance system in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

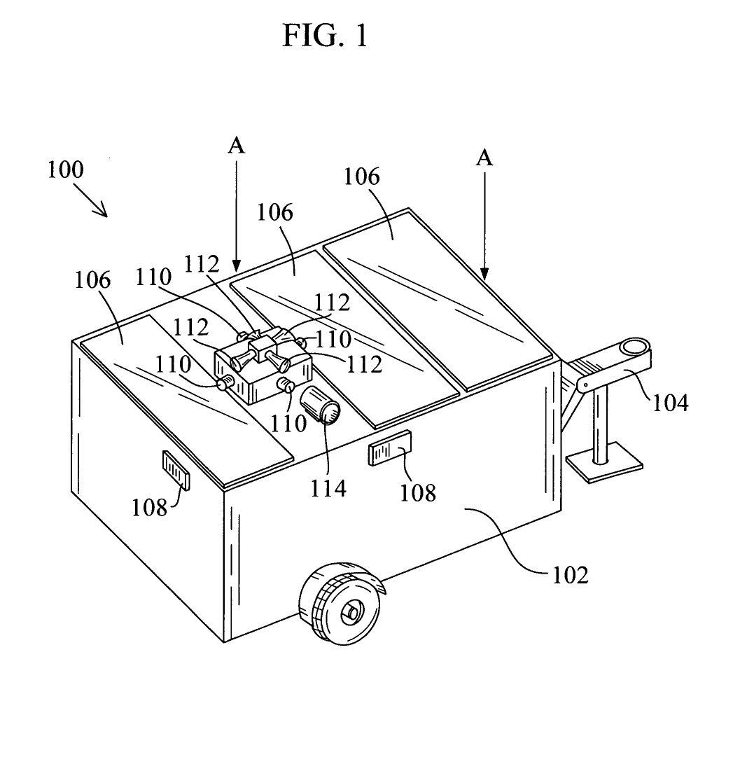

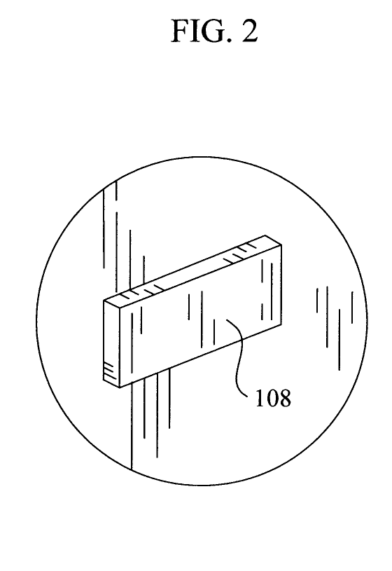

Turning now to FIG. 1 and FIG. 2:

FIG. 1 depicts a perspective view of one embodiment of a mobile monitoring and surveillance system in accordance with the inventive disclosures herein. FIG. 2 depicts a view of additional motion sensor locations depicted by ‘A’ of FIG. 1 in accordance with the inventive disclosures herein. A mobile monitoring and surveillance system 100 for monitoring activities at a remote protected area, the system includes a wheeled trailer frame with weather tight enclosure 102 and a hitch 104 for removably securing the trailer to and for being towed by a motor vehicle to a site to be protected. Three solar panels 106 having an array of solar voltaic cells are secured to roof of the enclosure 102, the solar voltaic cells for converting sunlight into electricity to power the surveillance system. Four motion sensors 108 are depicted. At least one motion sensor secured to an outside surface of each wall of the enclosure. Additional motion sensors may be used to increase the coverage if needed. Four video cameras 110 are shown. The video cameras 110 are secured to the roof of the enclosure 102. The cameras are positioned to provide 360 degree coverage of the area around the enclosure. Four flood lights secured to the roof of the enclosure and positioned to illuminate a 360 degree coverage area around the enclosure. Each flood light 112 is electrically connected to the energy storage means and individually controlled by the computer system of the monitoring and surveillance system. A siren 114 is secured to the roof of the enclosure of the trailer.

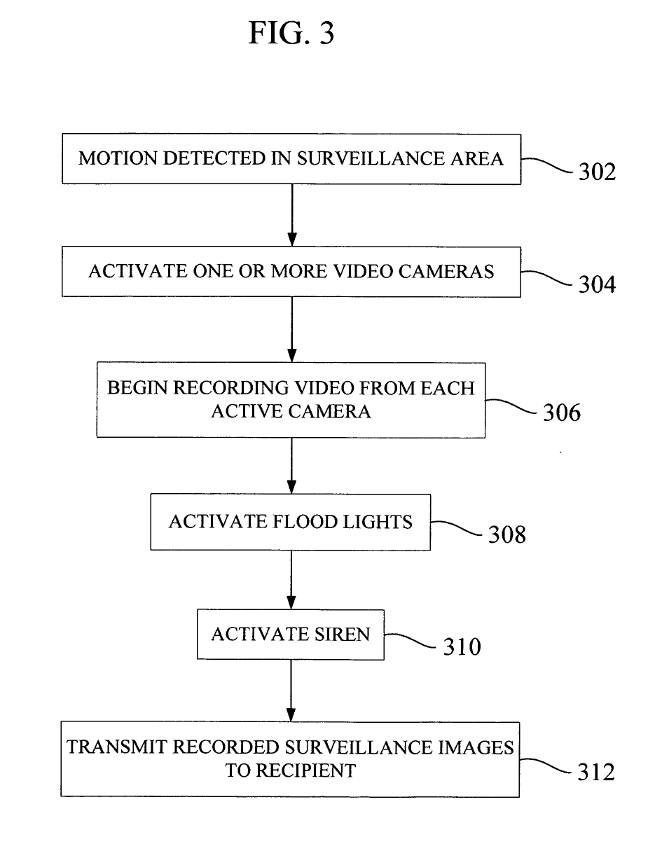

Turning now to FIG. 3:

FIG. 3 is a flow diagram of a method of detecting, capturing images and reporting undesirable activity in accordance with the inventive disclosures herein. At block 302 motion is detected within the protected area surrounding the mobile monitoring and surveillance system. The detection is typically from a motion sensor trip. The motion sensors feed detection inputs into the computer system which responds by activating one or more of the video cameras at block 304. At block 306 the computer begins recording video or images from one or more activated video cameras. Recording is done to non-volatile data store of the computer or alternately directly to DVD or CD formats. At block 308 the computer may be optionally programmed to activate one or more flood lights, the additional lighting provides a better and more detailed view of the intruders and events taking place. If night vision cameras are used, then this is useful but not absolutely necessary. At block 310 the computer may optionally activate the siren to provide an audible warning to the intruder, draw attention to the actions of the intruder and hopefully frighten the intruder(s) away from the protected area. At block 312 the surveillance images and video are transmitted via a wireless means such as the Internet or satellite to one or more recipients, thereby notifying the recipients of the detected intrusion and provided video evidence.

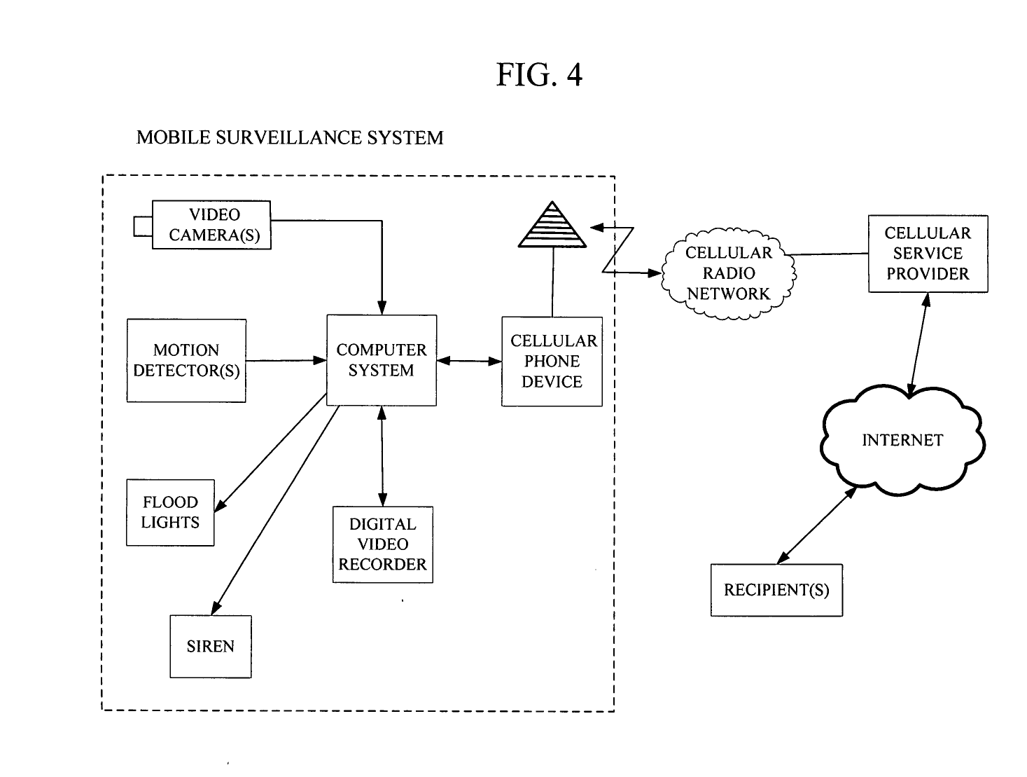

Turning now to FIG. 4:

FIG. 4 is a block diagram of one embodiment of a mobile monitoring and surveillance system in accordance with the inventive disclosures herein. The mobile monitoring and surveillance system 400 has a plurality of video cameras 406 interfaced to the computer system 402 by which the computer is able to capture video and still images. A plurality of motion detectors 404 are interfaced to the computer system to alert the computer system 402 when motion is detected within the protected area surrounding the mobile monitoring and surveillance system. Flood lights 408 are controlled by the computer system 402 which can be programmed to activate one or multiple flood lights. For example, if motion is detected to the rear of the mobile monitoring and surveillance system, then it may be programmed to activate only the rear flood light. A siren 410 is interfaced to the computer system 402 and is actuated by the computer to annunciate an alarm and draw attention to an intruder. One or multiple digital video recorder devices 412 are interfaced to the computer system to record still images and motion video from detected intruder alarm conditions. A cellular phone device 414 is connected to an antenna 416 providing Internet access to the computer system 402, enabling surveillance video and images to be transmitted through a cell service provider 420 to the Internet 422 and on to one or more recipients 424. The depicted transmission method is one method of many and the disclosure is not limited to the use of a cellular phone having wireless Internet access as depicted. Other methods are envisioned including direct RF transmission, transmission of a satellite uplink/downlink, transmission over a hardwired dialup telephone line, WiFi wireless 802.11b networking, a phone and modem, as well as retaining images in the local digital video recorder or non-volatile storage of the computer and providing remote access to these images over the Internet through a FTP server or web server executing on the computer system 402.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A mobile monitoring and surveillance system for monitoring activities at a remote protected area, the system comprising:
a wheeled trailer frame with a hitch for removably securing to and being towed by a motor vehicle;
a weather tight enclosure secured to the trailer frame, the enclosure having a front wall, opposing side walls, a rear wall and a roof;
one or more panels having an array of solar voltaic cells secured to roof of the enclosure, the solar voltaic cells for converting sunlight into electricity to power the surveillance system;
an energy storage means comprising at least one rechargeable battery;
a DC to AC power inverter for supplying 120 VAC power from the energy storage means, the inverter electrically connected to the energy storage means and solar voltaic cells, the inverter secured to the interior of the enclosure;
a computer system secured to the interior of the enclosure, the computer system having programmable logic control functionality for surveillance monitoring, the computer system having:
a processor;
memory;
a non-volatile storage means for storing an operating system, application software, recorded video and audio surveillance data and surveillance configuration information;
keyboard;
mouse; and
at least one display monitor;
a plurality of motion sensors, at least one motion sensor secured to an outside surface of each wall of the enclosure, the motion sensors interfaced to the computer system, the motion sensors for detecting movement within the remote protected area, the motion sensors electrically interfaced to the computer, the motion sensors having adjustable range/sensitivity settings;
a plurality of video cameras, the video cameras secured to the roof of the enclosure, the camera positioned to provide substantially 360 degree coverage of the area around the enclosure, the cameras electronically interfaced to the computer;
at least one digital video recorder having audio and video recording capabilities, the digital video recorder interfaced to the computer system, the video recorder for recording still images as well as motion images with audio from the video cameras;
a siren secured to the enclosure and electrically interfaced to the computer system, the siren for annunciating when an intrusion has been detected;
one or more heaters for electronic devices such as the digital video recorder and programmable logic controller;
a wireless transmission means for transmitting surveillance video and images;
a plurality of flood lights secured to the roof of the enclosure and positioned to illuminate a 360 degree coverage area around the enclosure, the flood lights electrically connected to the energy storage means and controlled by the computer system, wherein when motion is detected the computer may be programmed to illuminate in a direction where the motion was detected for better video image capture; and
at least one communications antenna secured to the enclosure and electrically interfaced to the wireless transmission means,
wherein when motion is detected in the protected area the siren and lights are triggered and the cameras capture video images, the computer system recording the images to the data store or digital video recorder, the images optionally transmitted to a recipient via the cellular phone connection to the Internet.

2. The mobile monitoring and surveillance system of claim 1, wherein:
the non-volatile storage means is at least one hard disk drive; and wherein
the wireless transmission means is a cellular phone device having a cellular modem interfaced to the computer control system, the cellular device having Internet access capabilities, the cellular device for connecting the computer to the Internet.

3. The mobile monitoring and surveillance system of claim 2, wherein:
the video camera is a CCD night/day infrared video camera; and wherein
the motion sensors are passive infrared sensors for detecting movement of infrared emitting sources such as a human body.

4. The mobile monitoring and surveillance system of claim 3, wherein:
the video camera includes carbonite composite light emitting diodes for illuminating a remote target.

5. The mobile monitoring and surveillance system of claim 1, further comprising:
the wireless transmission means is a satellite transmitter/receiver.

6. The mobile monitoring and surveillance system of claim 1, wherein:
the digital video recorders are DVD-R/W devices interfaced to the computer system.

7. The mobile monitoring and surveillance system of claim 3, wherein:
the recipient is a law enforcement agency.

8. The mobile monitoring and surveillance system of claim 1, further comprising:
one or more heaters for warming electronic devices such as the digital video recorder in cold weather conditions.

9. A method of detecting, capturing images and reporting undesirable activity in a remote protected area utilizing a mobile monitoring and surveillance system, the method comprising:
detecting motion in a surveillance area;
activating one or more video cameras;
recording video from each active camera;
illuminating the area where motion is detected using one or more flood lights;
annunciating the detected undesirable activity using a siren; and
transmitting the recorded video to one or more recipients.
